(19) United States
(12) Patent Application Publication
(10) Pub. No.: US 2023/0162259 A1
(43) Pub. Date: May 25, 2023

(54) ITEM RECOMMENDATION BY CHATBOT

(71) Applicant: Hewlett-Packard Development Company, L.P., Spring, TX (US)

(72) Inventors: Sandip Brahmachary, Pune (IN); Narendra Kumar Chincholikar, Pune (IN)

(73) Assignee: Hewlett-Packard Development Company, L.P., Spring, TX (US)

(21) Appl. No.: 17/912,535

(22) PCT Filed: May 26, 2020
(86) PCT No.: PCT/US2020/034509

§ 371 Date: Sep. 19, 2022

(30) Foreign Application Priority Data
Apr. 1, 2020 (IN) 202041014531

(51) Int. Cl. G06Q 30/0601; G06Q 50/00

(52) U.S. Cl. CPC G06Q 30/0631; G06Q 50/01

(57) ABSTRACT

In an example implementation according to aspects of the present disclosure, a system monitors a social media platform used by a user for information entered by the user in association with a type of item. In response to identifying the information entered by the user in association with the type of item, the system analyzes the information to determine a user's interest in the type of item. A recommendation of at least one item is generated for the user based on the type of item and the determined user's interest in the type of item. The recommendation of the at least one item is communicated, by a chatbot, to the user on the social media platform used by the user.

### BACKGROUND

A chatbot includes a system that is able to conduct a conversation with a human user or another entity. The chatbot can receive commands and perform services in response to the commands.

### BRIEF DESCRIPTION OF THE DRAWINGS

Many aspects of the disclosure can be better understood with reference to the following drawings. While several examples are described in connection with these drawings, the disclosure is not limited to the examples disclosed herein.

FIG. 1 illustrates a block diagram of a computing system for recommending an item to a user by a chatbot, according to an example;

FIG. 2 illustrates a flow diagram of a process to recommend an item to a user by a chatbot, according to an example;

FIG. 3 illustrates a block diagram of a non-transitory storage medium storing machine-readable instructions to recommend an item to a user by a chatbot, according to an example;

FIG. 4 illustrates an operational architecture of a system for recommending an item to a user by a chatbot, according to another example;

FIG. 5 illustrates a sequence diagram for a process to generate a recommended offer for an item to a user by a chatbot, according to another example;

FIG. 6 is a block diagram illustrating a system to recommend an item to a user by a chatbot, according to another example; and

FIG. 7 illustrates is a flow diagram illustrating a process to recommend an item to a user by a chatbot, according to another example.

### DETAILED DESCRIPTION

The disclosure described herein presents a system, method, and storage medium storing instructions that allow a chatbot to provide a user with purchasing recommendations based on information provided by the user in a social media application. The system monitors a social media application used by a user for information entered by the user in association with a type of item. In response to identifying the information entered by the user in association with the type of item, the system analyzes the information to determine a user's interest in the type of item. The system then generates a recommendation of an item for the user based on the type of item and the determined user's interest in the type of item. A chatbot then provides the recommendation of the item to the user in the social media application used by the user.

Social media platforms have become a commonplace for users to post interests in products to buy. In many instances, an analysis of keywords in the user's posts may indicate a sentiment of the user, such as the type of product the user intends to purchase, the user's level of interest in the product, and a level of urgency to purchase the product. Furthermore, keywords and other symbols (e.g., emojis) may also indicate whether the user has a positive or negative sentiment about the product. These keywords may be analyzed using a Natural Language Processing (NLP) model.

A chatbot can be referred to as an intelligent virtual assistant or any other type of electronic agent that allow end users to interact with the chatbot using NLP as input. The chatbot can simulate an intelligent conversational interface that enables interactive chat sessions with human users via auditory or textual techniques. A chatbot can include machine-readable instructions that perform the tasks of the chatbot, or a combination of a hardware processing circuit and the machine-readable instructions that are executable on the hardware processing circuit to perform the tasks of the chatbot.

While many systems may use NLP of a user's search history in a browser to analyze a user's consumer habits, these methods do not offer interact with a user on a social media platform. Furthermore, these methods do not provide an automated approach to analyze the social media posts, determine a user's sentiment, determine available offers for the user, and recommend the offers to the user using a chatbot.

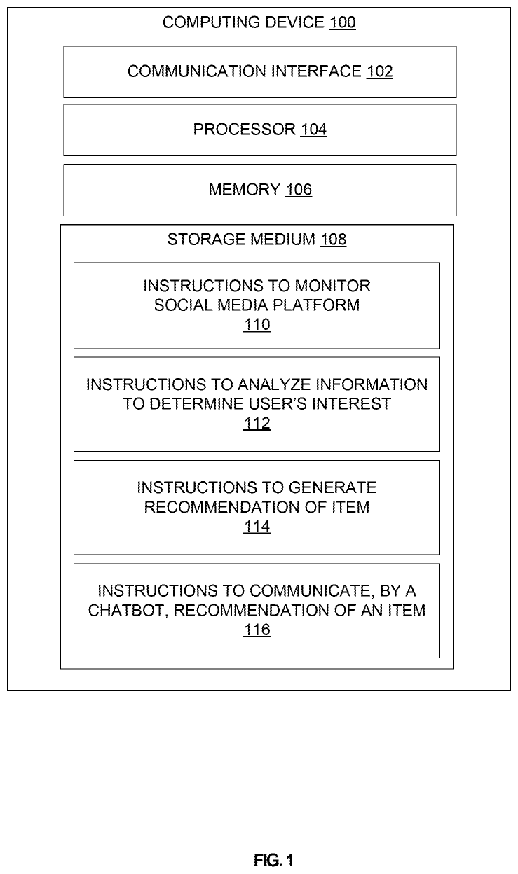

FIG. 1 illustrates a block diagram of computing system 100 for recommending an item to a user by a chatbot, according to an example. Computing system 100 depicts communication interface 102, processor 104, memory 106, and storage medium 108. As an example of computing device 100 performing its operations, storage medium 108 may include instructions 110-116 that are executable by processor 104. Thus, storage medium 108 can be said to store program instructions that, when executed by processor 104, implement the components of computing device 100.

In particular, the executable instructions stored in storage medium 108 include, as an example, instructions to monitor a social media platform used by a user for information entered by the user in association with a type of item (110) and instructions to analyze the information to determine a user's interest in the type of item in response to identifying the information entered by the user in association with the type of item (112). The executable instructions stored in storage medium 108 also include, as an example, instructions to generate a recommendation of the item for the user based on the type of item and the determined user's interest in the type of item (114) and instructions to provide, from the communication interface and over a chatbot, the recommendation of the item to the user in the social media application used by the user (116).

The instructions to monitor the social media platform used by the user for information entered by the user in association with the type of item (110) represent program instructions that when executed by processor 104 cause computing device 100 to follow a user's profile on a social media platform and track posts made by the user. The posts made by the user may include language which refers to a product type, a reference to a company, and keywords which indicate the user's urgency in purchasing the product type. As an example, communication interface 102 may detect that a user has posted that this year on a fire sale, they would like to purchase a laptop for his daughter who is currently in college. The user further posts that they would like suggestions on a laptop that would be best for college projects, gaming, and streaming media. Communication interface 102 may also detect other symbols in the post, such as emojis and hashtags. It should be noted that the information entered by the user on the social media platform may be extracted using one or more social media public Application Programming Interfaces (APIs). More specifically, a Social Media Aggregator API may be used to read from a social media platform graph.

The instructions to analyze the information to determine a user's interest in the type of item in response to identifying the information entered by the user in association with the type of item (112) represent program instructions that when executed by processor 104 cause computing device 100 to use NLP to determine the type of item and the user's sentiments about the item. The analysis can provide interest of the user on what apparatus the user is interest in, such as a laptop, scanner, printer, keyboard, etc. The analysis may further provide information on which model the user is focusing on and/or which configuration the user is interested in. In some examples, the analysis may also indicate a buying urgency of the user, such as a date the user is planning to purchase the product. In yet another example, the analysis may indicate a user profile, such as a student.

Referring to the previous example, the keywords from the user's post indicate that the type of item that the user is interested in is a laptop. Furthermore, the user has indicated that the item is associated with a user profile of a student. The keywords in the user's post may also be analyzed to determine that the user plans to purchase the item on a holiday.

The instructions to generate a recommendation of the item for the user based on the type of item and the determined user's interest in the type of item (114) represent program instructions that when executed by processor 104 cause computing device 100 to process the information along with historical data to determine an offer for the item. In many cases, a set of offers may be generated based on the information. For example, an offer for the product may be determined from a company's marketing database. Additional offers may also be included, such as offers for headsets, gaming equipment, keyboards, etc. Depending on the information, package offers for a combination of products may also be generated.

In some examples, data associated with the type of item may be maintained in a cloud-based data repository to be ingested by a machine learning system. Further in this example, a machine learning model may be built with information associated with a plurality of items, a plurality of user profiles, and a plurality of item offers. For example, data about a variety of laptop models and configurations may be stored in a database along with data about current marketing offers associated with each of the laptop models and configurations.

The instructions to communicate, from the communication interface and over the chatbot, the recommendation of the item to the user in the social media application used by the user (116) represent program instructions that when executed by processor 104 cause computing device 100 to automatically approach the user on the social media platform by the chatbot to suggest the item. The chatbot may also recommend an item model, configuration, and an offer to the user for purchasing the item. As an example, a user may be contacted by the chatbot with a list of available offers for a laptop which are available on a fire sale.

Storage medium 108 represents any number of memory components capable of storing instructions that can be executed by processor 104. As a result, memory 106 may be implemented in a single device or distributed across devices. Likewise, processor 104 represents any number of processors capable of executing instructions stored by storage medium 108. Processor 104 may be fully or partially integrated in the same device as processor 104, or processor may be separate but accessible to that device and processor 104.

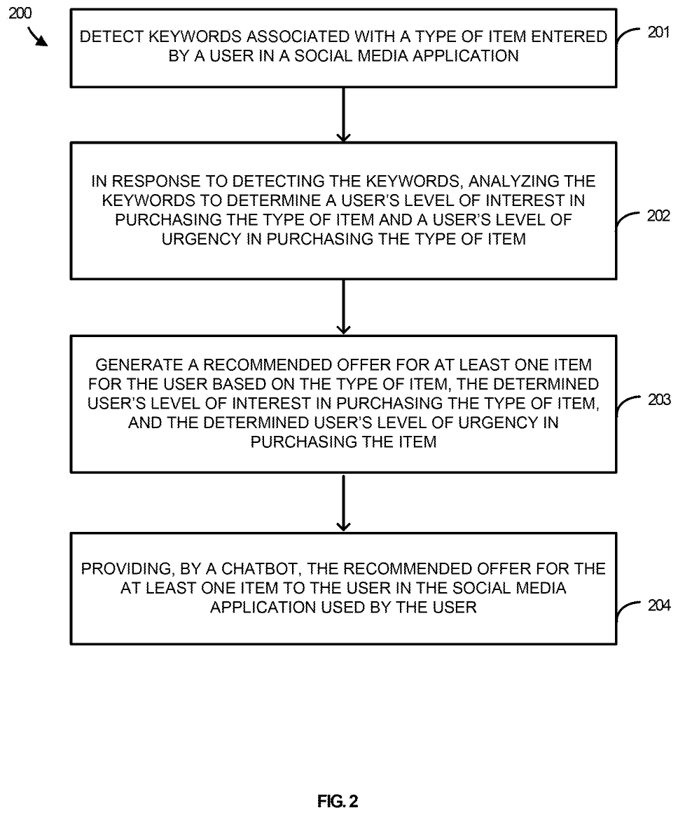

FIG. 2 illustrates a flow diagram of process 200 to recommend an item to a user by a chatbot, according to an example. Some or all of the steps of process 200 may be implemented in program instructions in the context of a component or components of an application used to carry out the item recommendation feature. Although the flow diagram of FIG. 2 shows a specific order of execution, the order of execution may differ from that which is depicted. For example, the order of execution of two of more blocks shown in succession by be executed concurrently or with partial concurrence. All such variations are within the scope of the present disclosure.

Referring parenthetically to the steps in FIG. 2, a process detects (201) keywords associated with a type of item entered by a user in a social media application. The keywords entered by the user in association with the type of item may be identified using an NLP model. In other examples, in response to detecting the keywords entered by the user in association with the type of item, the process further comprises detecting keywords indicating characteristic data associated with the user. For example, a user may post that, as an owner of a small company, she is looking for recommendations in purchasing new workstations and printers. The post may further include hashtags followed by a company name.

In a next operation, the process analyzes (202) the keywords to determine a user's level of interest in purchasing the type of item and a user's level of urgency in purchasing the type of item in response to detecting the keywords. Determining a user's level of interest in purchasing the type of item may include analyzing keywords used in the post along with the keywords indicating the type of item to determine whether the user has a positive or negative sentiment around the item. Referring to the current example, the hashtag referring to the company in the post asking for workstation and printer recommendations may indicate that the user likes that company and is looking for recommended products from the company.

Determining a user's level of urgency in purchasing the type of item may be determined by analyzing keywords in the user's post which refer to a date which the user plans to buy the product such as, by the end of this month, by a specified holiday, or before an upcoming season (e.g., by the beginning of a school year). In some example scenarios, in response to detecting the keywords entered by the user in association with the type of item, the process may further comprise detecting keywords indicating characteristic data associated with the user. For example, keywords may be analyzed to determine whether the user is purchasing the item for a student, an employer of a business, a minor, etc.

Next, the process generates (203) a recommended offer for an item for the user based on the type of item, the determined user's level of interest in purchasing the type of item, and the determined user's level of urgency in purchasing the item. As an example, it may be determined that a package deal can currently be made for a set of workstations and printers. This offer of the package deal is determined based on what offers can be made available to the user at the present time, as well as the types of items that the user is seeking to purchase.

In some examples, data associated with the type of item may be stored in a cloud-based data repository to be ingested by a machine learning system. For example, a data repository may contain all combinations of offers on items along with a period of time in which the items can be purchased using the offer. Further in this example, a machine learning model may be built with data associated with a plurality of items and a plurality of offers to purchase the items. Therefore, machine learning algorithms and techniques may be used to determine available offers for a user based on the type of item the user is looking to purchase, the user's urgency in purchasing the item, the user's level of interest, etc.

In further examples, data associated with the user may also be user profile information to determine the offer. For example, if it is determined that the user is associated with a student profile, the offer may be determined based on student discounts, popular items that other students have purchased, and suggested additional items that the student may need in addition to the item. In another example, multiple user profiles may be maintained in association with an item type. In this example, each type of item may have a different suggested model, configuration, accessories, etc. which would be associated with the user profile. The offer may then be generated to reflect the user profile information.

The process then provides (204), by a chatbot, the recommended offer for the item to the user in the social media application used by the user. The recommended offer may be provided to the user by the chatbot posting the offer in the user's original thread post on the social media application. The recommended offer may further be provided to the user by the chatbot sending a private message to the user which provides the offer and contact information for the user to purchase the item in the offer. It should also be noted that process 200 may be running continuously, be run at predefined intervals, be run at random intervals, or be triggered to run in response to a user activity.

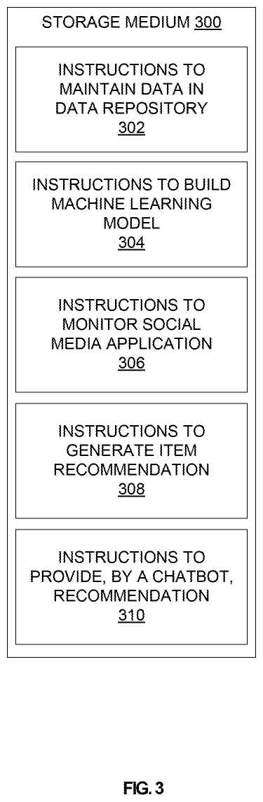

FIG. 3 illustrates a block diagram of non-transitory storage medium 300 storing machine-readable instructions that upon execution cause a system to recommend an item to a user by a chatbot, according to an example. Storage medium is non-transitory in the sense that is does not encompass a transitory signal but instead is made up of a memory component configured to store the relevant instructions.

The machine-readable instructions include instructions to maintain data associated with the type of item in a cloud-based data repository to be ingested by a machine learning system (302). The machine-readable instructions also include instructions to build a machine learning model with information associated with a plurality of items and a plurality of user profiles (304) and instructions to monitor a social media application used by a user for information entered by the user in association with a type of item (306). Furthermore, the machine-readable instructions include instructions to generate a recommendation of the item for the user based on the type of item in response to identifying the information entered by the user in association with the type of item (308) and instructions to provide, by a chatbot, the recommendation of the item to the user in the social media application used by the user (310).

In this example, the machine learning model may be built to follow a rule-based approach. For example, the machine learning model follow the 60-20-20 rule in which 60% of data will be used for building the model, 20% will be used for validating the model and rectifying the parameters to tune the model to get the improved accuracy, precession, recall other statistical metrics, and the remaining 20% will be used to test the model.

In this example, source of data for the machine learning model may be selected based on hashtags followed by keywords indicating a user's interest in an item type or a company. The source may include real-time posts, reposts, replies to posts, etc. Furthermore, the data may be identified and stored in the data repository to be ingested by the machine learning model using a Python library or Apache flume. Similarly, the chatbot may be initiated to approach the user if a recommended offer is determined. In this manner, the chatbot may interact with the user using the social media application, a messaging extension within the social media application, or some other method of communicating the offer with the user.

In yet another example, the process may further select sentiment keywords from the hashtag or posts. For example, a post stating that the user has always used a tablet from a select company may indicate that the user would prefer another tablet from the select company. Further in this example, the machine learning model may process the sentiment keywords along with the keywords indicating the type of item and the company to generate the recommended offer for the user.

In one example, program instructions 302-310 can be part of an installation package that when installed can be executed by a processor to implement the components of a computing device. In this case, non-transitory storage medium 300 may be a portable medium such as a CD, DVD, or a flash drive. Non-transitory storage medium 300 may also be maintained by a server from which the installation package can be downloaded and installed. In another example, the program instructions may be part of an application or applications already installed. Here non-transitory storage medium 300 can include integrated memory, such as a hard drive, solid state drive, and the like.

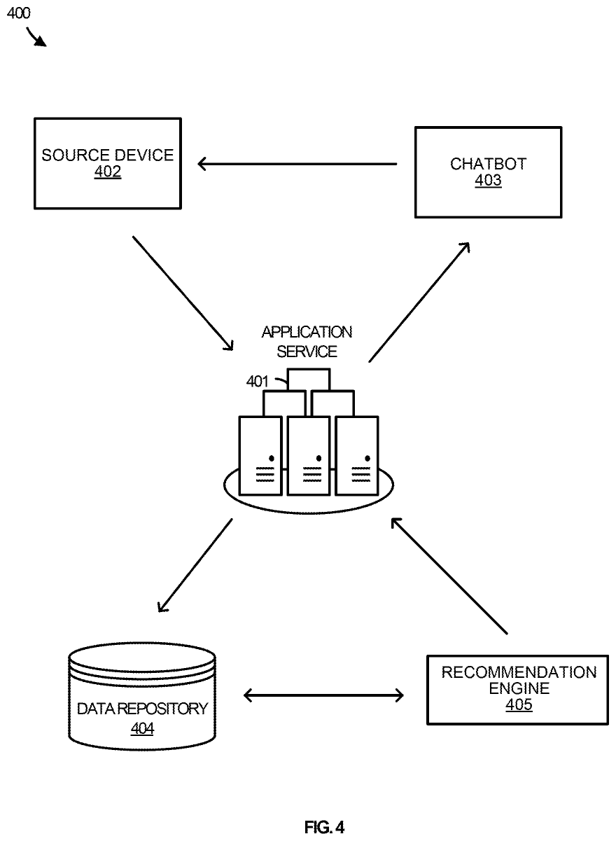

FIG. 4 illustrates an operational architecture of a system for recommending an item to a user by a chatbot, according to another example. FIG. 4 illustrates operational scenario 400 that relates to what occurs when purchasing data is stored in a data repository and the offer is generated using machine learning algorithms or techniques in a recommendation engine. Operational scenario 400 includes application service 401, computing device 402, chatbot 403, data repository 404, and recommendation engine 405.

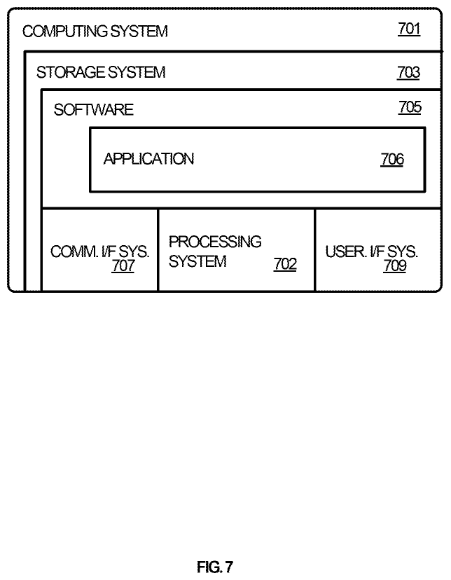

Application service 401 is representative of any device capable of running an application natively or in the context of a web browser, streaming an application, or executing an application in any other manner. Examples of application service 401 include, but are not limited to, personal computers, mobile phones, tablet computers, desktop computers, laptop computers, wearable computing devices, or any other form factor, including any combination of computers or variations thereof. Application service 401 may include various hardware and software elements in a supporting architecture suitable for performing process 500. One such representative architecture is illustrated in FIG. 7 with respect to computing system 701.

Application service 401 also includes a software application or application component capable of generating an offer recommendation in accordance with the processes described herein. The software application may be implemented as a natively installed and executed application, a web application hosted in the context of a browser, a streamed or streaming application, a mobile application, or any variation or combination thereof.

As shown in FIG. 4, users may user computing device 402 to interact with application service 401 and chatbot 403. Examples of user devices include any or some combination of the following: a desktop computer, a notebook computer, a tablet computer, a smartphone, a game appliance, a wearable device (e.g., a smart watch, a head-mount device, etc.), or any other type of electronic device. Computing device 402 includes an input device, such as a microphone and/or keyboard or touchscreen, to allow the user to enter information indicating the user's interest in an item.

Data repository 404 may be any data structure (e.g., a database, such as a relational database, non-relational database, graph database, etc.), a file, a table, or any other structure which may store a collection of data. Based on the data stored in data repository 404, recommendation engine 405 is able to generate recommended offers for items.

Data repository 404 maintains and tracks purchasing data for generating an offer to be provided to a user. The purchasing data may include item data, item configuration data, item model data, user profile data, accessory data, pricing package data, date and time data associated with an offer, or a combination of purchasing data associated with an item. Data repository 404 may maintain a variety of recommended offers which are associated with a variety of types of items.

Recommendation engine 405 processes the received data from data repository 404 and the purchasing information from computing device 402 over application service 401. Recommendation engine 405 may be a rule-based engine which may process a selection of keywords and combinations of keywords to determine an item type, a positive or negative sentiment associated with the item type, user profile information, user urgency in purchasing the item, etc. to generate the recommended offer for the user. Recommendation engine 405 may further include a data filtrations system which filters the selected keywords and hashtags to determine data which will be used in generating the recommended offer. In some examples, recommendation engine 405 may use a statistical supervised model to filter the data and generate the recommended offer.

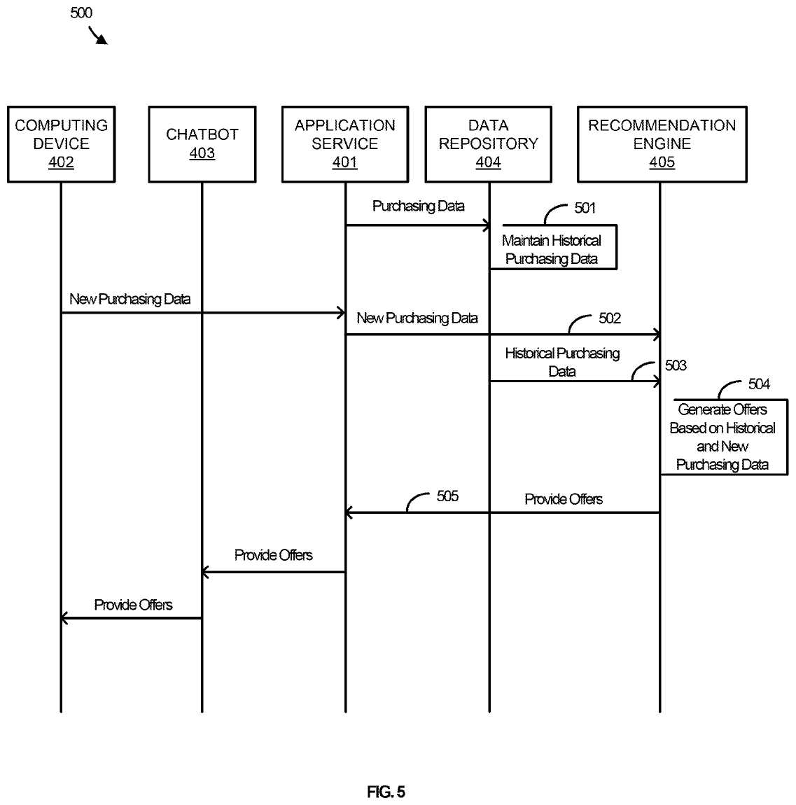

FIG. 5 illustrates a sequence diagram for process 500 to generate a recommended offer for an item to a user by a chatbot, according to another example. Specifically, the sequence diagram illustrates an operation of system 400 to generate an offer recommendation when purchasing data is stored in a data repository and processed using machine learning techniques in a recommendation engine.

In a first step, data repository 404 collects and maintains (501) historical purchasing data, such as various items for purchase, models and configurations of the items, offers to purchase items, timelines for which the offers are valid, accessories associated with the item, user profiles, etc. In a next step, application 401 collects (502) new purchasing data from computing device 402 indicating a user's interest in purchasing an item, the user's level of urgency in purchasing the item, and user profile information, and transfers the new purchasing data to recommendation engine 405. For example, a user may have posted that their old laptop is going to stop working soon and that the user is looking for recommendations for a laptop to stream media and game on while traveling. Application service 401 may use various social media APIs to collect the new purchasing data.

In a next step, the historical purchasing data is retrieved (503) from data repository 404 and sent to recommendation engine 405 to be processed using machine learning techniques. For example, the historical purchasing data may include laptops that other users who stream media and travel have purchased. Recommendation engine 405 then processing the historical purchasing data and the new purchasing data to determine (504) one or more offers for the user to purchase. In a final operation, the recommended offers are then provided (505) to computing device 402 by chatbot 403. For example, chatbot 403 may post that the recommendation offers in response to the original post entered by the user of computing device 402.

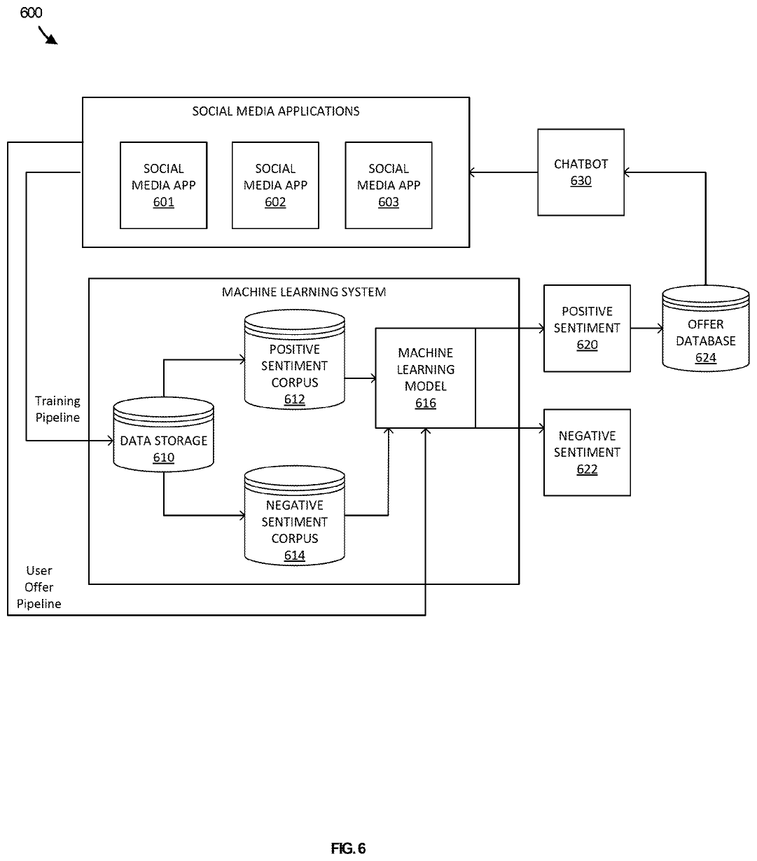

FIG. 6 is a block diagram illustrating system 600 to generate recommended offers for a user, according to another example. Some or all of the steps of performed by system 600 may be implemented in program instructions in the context of a component or components of an application used to carry out the offer recommendation feature. Block diagram 600 includes social media applications 601-603, a machine learning system, positive sentiment engine 620, negative sentiment engine 622, offer database 624, and chatbot 630. The machine learning system include data storage 610, positive sentiment corpus 612, negative sentiment corpus 614, and machine learning model 616.

As illustrated in FIG. 6, data may be pulled from social media applications 601-603 to train the machine learning system. Specifically, data retrieved from social media application 601-603 may be stored in data storage 610. Positive sentiments are determined using positive sentiment corpus 612 and negative sentiments are determined using negative sentiment corpus 614. Next, machine learning model 616 is built using the retrieved data, the positive sentiments, and the negative sentiments.

Next, the user offer pipeline illustrated on FIG. 6 shows that user posts may be pulled from social media applications 601-603 to be ingested by machine learning model 616. Machine learning model 616 then determines whether the user's post contains positive sentiments or negative sentiments regarding the item. If the sentiment around the item is positive, one or more offers are generated by offer database 624 and delivered to the user of social media applications 601-603 over chatbot 630.

FIG. 7 illustrates computing system 701, which is representative of any system or visual representation of systems in which the various applications, services, scenarios, and processes disclosed herein may be implemented. Examples of computing system 701 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 701 may be implemented as a single apparatus, system, or device or may be implemented in a distributed manner as multiple apparatuses, systems, or devices. Computing system 701 includes, but is not limited to, processing system 702, storage system 703, software 705, communication interface system 707, and user interface system 709. Processing system 702 is operatively coupled with storage system 703, communication interface system 707, and user interface system 709.

Processing system 702 loads and executes software 705 from storage system 703. Software 705 includes process 706, which is representative of the processes discussed with respect to the preceding FIGS. 1-5, including process 200. When executed by processing system 702 to enhance an application, software 705 directs processing system 702 to operate as described herein for at least the various processes, operational scenarios, and sequences discussed in the foregoing examples. Computing system 701 may optionally include additional devices, features, or functionality not discussed for purposes of brevity.

Referring still to FIG. 7, processing system 702 may comprise a micro-processor and other circuitry that retrieves and executes software 705 from storage system 703. Processing system 702 may be implemented within a single processing device, but may also be distributed across multiple processing devices or sub-systems that cooperate in executing program instructions. Examples of processing system 702 include general purpose central processing units, graphical processing unites, application specific processors, and logic devices, as well as any other type of processing device, combination, or variation.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or other suitable storage media, except for propagated signals. Storage system 703 may be implemented as a single storage device, but may also be implemented across multiple storage devices or sub-systems co-located or distributed relative to each other. Storage system 703 may comprise additional elements, such as a controller, capable of communicating with processing system 702 or possibly other systems.

Software 705 may be implemented in program instructions and among other functions may, when executed by processing system 702, direct processing system 702 to operate as described with respect to the various operational scenarios, sequences, and processes illustrated herein. Software 705 may include program instructions for implementing process 200.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtual machine software, or other application software, in addition to or that include process 706. Software 705 may also comprise firmware or some other form of machine-readable processing instructions executable by processing system 702.

In general, software 705 may, when loaded into processing system 702 and executed, transform a suitable apparatus, system, or device (of which computing system 701 is representative) overall from a general-purpose computing system into a special-purpose computing system. Indeed, encoding software 705 on storage system 703 may transform the physical structure of storage system 703. The specific transformation of the physical structure may depend on various factors in different examples of this description. Such factors may include, but are not limited to, the technology used to implement the storage media of storage system 703 and whether the computer-storage media are characterized as primary or secondary storage, as well as other factors.

If the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 709 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 709. In some cases, the input and output devices may be combined in a single device, such as a display capable of displaying images and receiving touch gestures. The aforementioned user input and output devices are well known in the art and need not be discussed at length here. User interface system 709 may also include associated user interface software executable by processing system 702 in support of the various user input and output devices discussed above.

Communication between computing system 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here.

Certain inventive aspects may be appreciated from the foregoing disclosure, of which the following are various examples.

The functional block diagrams, operational scenarios and sequences, and flow diagrams provided in the Figures are representative of example systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. I should be noted that a method could alternatively be represented as a series of interrelated states or events, such as in a state diagram. Moreover, not all acts illustrated in a methodology may be required for a novel example.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

What is claimed is:

1. A system comprising a processor operatively coupled with a computer readable storage media and program instructions stored on the computer readable storage media that, when read and executed by the processor, direct the processor to:
monitor, using a communication interface, a social media platform used by a user for information entered by the user in association with a type of item;
in response to identifying the information entered by the user in association with the type of item, analyze the information to determine a user's interest in the type of item;
generate a recommendation of at least one item for the user based on the type of item and the determined user's interest in the type of item; and
communicate, from the communication interface and over a chatbot, the recommendation of the at least one item to the user on the social media platform used by the user.

2. The system of claim 1 wherein the recommendation of the at least one item for the user further comprises an offer for the at least one item based on the type of item and the determined user's interest in the item.

3. The system of claim 1 wherein the information associated with the type of item comprises information associated with at least a type of product or a type of service.

4. The system of claim 1 wherein, in response to identifying the information entered by the user in association with the type of item, the program instructions further direct the processor to identify information associated with the user and analyze the information associated with the user to determine a user profile.

5. The system of claim 4 wherein the program instructions further direct the processor to generate the recommendation of the at least one item for the user based on the determined user profile.

6. The system of claim 1 wherein the information associated with the type of item comprises information indicating a user's urgency in purchasing the type of item.

7. The system of claim 1 wherein the program instructions further direct the processor to maintain data associated with the type of item in a cloud-based data repository to be ingested by a machine learning system.

8. The system of claim 7 wherein the program instructions further direct the processor to build a machine learning model with information associated with a plurality of items, a plurality of user profiles, and a plurality of item offers.

9. The system of claim 1 wherein the information entered by the user in association with the type of item is identified using a Natural Language Processing (NLP) model.

10. A method comprising:
detecting keywords associated with a type of item entered by a user in a social media application;
in response to detecting the keywords, analyzing the keywords to determine a user's level of interest in purchasing the type of item and a user's level of urgency in purchasing the type of item;
generating a recommended offer for at least one item for the user based on the type of item, the determined user's level of interest in purchasing the type of item, and the determined user's level of urgency in purchasing the item; and
providing, by a chatbot, the recommended offer for the at least one item to the user in the social media application used by the user.

11. The method of claim 10 wherein in response to detecting the keywords entered by the user in association with the type of item further comprises detecting keywords indicating characteristic data associated with the user.

12. The method of claim 10 wherein the keywords entered by the user in association with the type of item are identified using a Natural Language Processing (NLP) model.

13. The method of claim 10 further comprising maintaining data associated with the type of item in a cloud-based data repository to be ingested by a machine learning system.

14. The method of claim 13 further comprising building a machine learning model with data associated with a plurality of items and a plurality of offers to purchase the items.

15. A system comprising a processor operatively coupled with a computer readable storage media and program instructions stored on the computer readable storage media that, when read and executed by the processor, direct the processor to:
maintain data associated with the type of item in a cloud-based data repository to be ingested by a machine learning system;
build a machine learning model with information associated with a plurality of items and a plurality of user profiles;
monitor a social media application used by a user for information entered by the user in association with a type of item;
in response to identifying the information entered by the user in association with the type of item, generate a recommendation of at least one item for the user based on the type of item; and
provide, by a chatbot, the recommendation of the at least one item to the user in the social media application used by the user.
